(19) United States
(12) Patent Application Publication
(10) Pub. No.: US 2005/0270589 A1
(43) Pub. Date: Dec. 8, 2005

(54) Image scanner

(76) Inventor: Yoshihisa Soeda, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/146,078

(22) Filed: Jun. 7, 2005

(30) Foreign Application Priority Data
Jun. 7, 2004 (JP) 2004-168855

(51) Int. Cl. H04N 1/407

(52) U.S. Cl. 358/461

(57) ABSTRACT

A method of correcting information scanned by an image scanner includes scanning a first number of positions of a first portion of a correction member having different reflectances to obtain first data. A second number of positions of a second portion of the correction member having different reflectances are scanned to obtain second data. The first data is transformed to obtain transformed first data. The second data is transformed to obtain transformed second data. A table that includes relationships between reflectances and differences of the transformed first data and the transformed second data is generated for a third number of positions greater than each of the first number of positions and the second number of positions.

### BACKGROUND OF THE INVENTION

1. Field of the Invention

The present invention relates to an image scanner, and more particularly to an image scanner configured to perform image correction.

2. Discussion of the Related Art

In a known image scanner, when a line of a document is scanned in a sub scanning direction, image information is focused on a surface of a charge-coupled device (CCD). The CCD outputs an analog signal corresponding to the scanned data.

FIG. 1 shows an example of an image scanner. The image scanner includes a lamp 7 to illuminate the document 5. First and second carriages 9 and 12, which include first, second and third mirrors 8, 10, and 11, are used to transmit light containing data corresponding to the image on the document 5 through a lens 13 to a signal processing board 14 including the CCD (referred to as the CCD 14). The first and second carriages 9 and 12 are moved in a known manner to scan the document 5. The analog output from the CCD 14 is converted to digital form in a known manner.

Before scanning the document 5, the whiteboard 3 is scanned to generate shading compensation data. The shading compensation data is stored in a memory. The generation of shading compensation data compensates for uneven light distribution within the image scanner, uneven sensitivities among portions of the CCD, and the like.

In the known image scanner, to increase the speed at which documents are scanned, the CCD includes multiple CCD shift registers capable of simultaneously scanning multiple portions of the document. The speed at which the document is scanned by this parallel processing of multiple portions of the document with the CCD is greater than the speed of a system that does not use multiple shift registers.

An example of the CCD including multiple shift registers includes a 2 channel odd/even output type CCD. Another example of the CCD including multiple shift registers includes a 4 channel CCD, in which odd and even outputs are provided for each of the first half and the last half of the document.

FIG. 2 shows an example of such a 4 channel CCD. As shown in the figure, the CCD 14 can include CCD analog shift register 1 to scan even number pixels of the first half portion of the document, CCD analog shift register 2 to scan odd number pixels of the first half portion of the document, CCD analog shift register 3 to scan even number pixels of the last half portion of the document, and CCD analog shift register 4 to scan odd number pixels of the last half portion of the document. Reset pins RS of the CCD 14 reset the output buffers. Shift pin SH opens shift gates 1 and 2, and shifts data to each of the registers. Output signal pin OS1 outputs from shift register 1. Output signals pins OS2-4 similarly output from shift registers 2-4, respectively.

Further each of the CCD analog shift registers 1-4 are connected to 2-phase transfer clocks φ1 and φ2. φ2B, which is a reversed phase of the 2-phase transfer clock φ2, is also connected to the each of the CCD analog shift registers 1-4. In addition, each of the outputs of the CCD analog shift registers has an output buffer amplifying an analog output data to the outside and shaping a waveform of the amplified analog output data.

In the known image scanner, the four CCD analog shift registers are used to scan the first half portion in a first direction and last half portion in a second direction opposite to the first direction. Thus, the CCD 14 of the present invention has a reading speed of 2 times faster than a 2 channel odd/even output type image sensor. The CCD 14, which is a 4 channel output image sensor (FB (front back) type image sensor) includes a light-sensitive element line divided in 2 at the center of a main scanning direction (i.e., divided into the first half portion and the last half portion).

Japanese laid-open patent publication no. 2000-188686, the contents of which is incorporated by reference herein in its entirety, shows a plural signal processing device executing predetermined signal processing to an image signal output from each output device of an image sensor of a first and last separation reading system and a standard board for white and gray colors. The publication further shows that the signal processing device matches the image signal level of the white standard board to a first predetermined level, and matches the image signal level of the gray standard board to a second predetermined level. Adjustment data is calculated to match image signal levels corresponding to a level interpolated between the first level and the second level. The image signal output is adjusted based on the adjustment data.

Japanese laid-open patent publication no. 2002-218186, the contents of which is incorporated by reference herein in its entirety, shows a tone pattern generated inside a device being output as an image, and correction processing calculating based on a difference between image data corresponding to the left side of 4 channel output CCD, as opposed to correcting processing calculating based on the right side of the 4 channel output CCD. The image data corresponding to the left is set as the standard data, and a γ correction is operated and a γ correction table is set.

Japanese laid-open patent publication no. 2002-158837, the contents of which is incorporated by reference herein in its entirety, shows a CCD line sensor divided into a first half odd portion and a last half even portion at the center of main-scanning direction. The image forming apparatus includes a sample hold circuit sampling and holding each output, a gain amplifier amplifying each output, a reading value detecting device detecting a maximum value of the image data reading the standard board or reading data of any images, and a processing device adjusting the amplification rate of the gain amplifier to be the same reading level of a connection of a first half part and a last half part.

However, in the image sensor using plural CCD shift registers there is a problem of variations of analog output delay times, caused by an unintended delay of a transfer start timing from the φ2B transfer clock to the output gate. The delay is caused by voltage potential variations at the last step of a shift register, as a result of variations of process conditions during formation of the CCD.

It is difficult to predict and account for differences between individual pixels even when the CCD device is a 2 channel device that provides odd and eve outputs, because differences between individual pixels may be only a single pixel unit. However, differences among outputs of the 4 channel device of the first half portion and the last half portion are increased by varying the delay time between signals output from the first half portion and the last half portion of the CCD.

FIG. 20 shows that a difference in potential of the φ2B transfer clock varies based on variations in the CCD, the variations in the CCD caused by imperfections in the manufacturing process of the CCD has a variation by a variation of a manufacturing process of CCD. As shown in the detail portion of the figure, a low signal corresponds to a low charge accumulation in the CCD, and a high signal corresponds to a high charge accumulation in the CCD. When the potential difference is increased, a transfer timing from the φ2B transfer clock to output gate is delayed if the electric charge accumulation in the CCD is decreased. The output signal also does not linearly correspond to a level of light measured by the CCD.

These variations of analog output delay times amplify noise caused by the CCD, and this noise affects differences between the first half portion and the last half portion. These variations especially affect analog output delay times corresponding to data measured by the CCD under low light levels. Differences between the linearity of the output signal and the outputs of the CCD analog shift registers are illustrated in FIG. 3.

The left over signal of FIG. 3 corresponds to the wave pattern output from the CCD analog shift register, the wave pattern output shown in FIG. 4. As shown in the left side of FIG. 3, when all the electric charge is output, linearity is good. This corresponds to the situation where the potential difference is small, and a small amount of electric charge is accumulated at a time of the output as determined by the φ2B transfer clock. In contrast, as shown in the right side of FIG. 3, when the electric charge is not completely output, linearity is poor. This corresponds to the situation wherein the potential difference is great, and a large amount of electric charge is accumulated at a time of the output as determined by the φ2B transfer clock. As illustrated in FIG. 3, by changing the difference in potential output at the time as determined by the φ2 transfer clock, a variation occurs in a delay time of analog output of OSm (a first half part of output signal: m=1-4) and OSn (a last half part of output signal: n=1-4), as shown in FIG. 4. The OSn (CCD output) signal shown in FIG. 4 is an example of the situation when the potential difference is small during a small time interval as determined by the φ2 transfer clock. The OSm (CCD output) signal shown in FIG. 4 is an example of the situation wherein the potential difference during a large time interval as determined by the φ2 transfer clock. The left side figure of FIG. 3 shows an example of a large amount of electric charge accumulated in the CCD. The difference in the analog output delay times results in a difference of linearity, and degrades the quality of the image at the boundary between the first and last half portions. The center figure of FIG. 3 shows the difference between the output of the CCD and the original signal.

The CCD can exhibit the characteristics shown in the right side of FIG. 3, when the CCD outputs data measured under low illumination. This same CCD can then exhibit the characteristics shown in the left side of FIG. 3, when the CCD outputs data measured under high illumination. Further, FIG. 4 shows the situation in which the output of the CCD signal of each output buffer begins when the φ2B transfer clock is at a low level. In the case of the CCD measuring output from the first half portion and the last half portion, it is possible that such variations of the delay times cannot be isolated by searching for a particular pixel at which the difference occurs.

It is possible that differences in linearity among the CCD shift register outputs cannot be compensated by shading correction, as shown in FIG. 5. In the CCD in which a first half portion and last half portion are measured, the level differences in linearity for a boundary between the first half portion and the last half portion cannot be compensated for by the shading correction, and therefore the differences in linearity for the boundary between the first half portion and the last half portion between medium density areas and high density areas may cause degradation in the quality of images produced as a result of the scanning.

To compensate for differences in linearity between CCD analog shift registers, a method to execute γ correction is shown, as applied to the output of each of the CCD analog shift registers, whether the CCD includes two or four CCD analog shift registers.

However, according to the method disclosed in Japanese laid-open patent publication no. 2000-188686, because an odd number pixel of a first half part and a last half part is synthesized with an analog signal, and an even number pixel of the first half part and the last half part are synthesized with an analog signal in the same way, there is the possibility of generating cross talk between the first half part data and last half part data. The cross talk can result in errors in the image formation.

In addition, according to the method disclosed in Japanese laid-open patent publication no. 2000-188686, costs are increased by using a memory for a look-up table for each of the CCD analog shift registers. Further, a precision of the correction may not be sufficient when depending on the criteria used to determine the level of correction.

It is possible to detect an average level of data of a connection near the boundary between the first half part and last half part of the data, by synthesizing an even number pixel and an odd number pixel of a first half part and synthesizing an even number pixel and an odd number pixel of a last half part. A difference in image density near the boundary is compensated for, and an abnormal image is prevented by γ correction of the data synthesized from an even number pixel and an odd number pixel of a first half part or an even number pixel and an odd number pixel of a last half part. The costs and time for reading data from memory can be reduced by reducing the memory size to the minimum size capable of storing the look-up table for a γ correction.

Further, when the memory storing the correction values is unexpectedly erased, it may not be possible to execute the correction and to avoid the generation of error images.

### SUMMARY OF THE INVENTION

The above and/or other advantages can be provided by the present invention, in which a method of correcting information scanned by an image scanner includes scanning a first number of positions of a first portion of a correction member having different reflectances to obtain first data. A second number of positions of a second portion of the correction member having different reflectances are scanned to obtain second data. The first data is transformed to obtain transformed first data. The second data is transformed to obtain transformed second data. A table that includes relationships between reflectances and differences of the transformed first data and the transformed second data is generated for a third number of positions greater than each of the first number of positions and the second number of positions.

The present invention provides an image reading apparatus including a CCD image sensor having plural shift registers configured to output data corresponding to a first portion and a last portion of a correction member scanned by the CCD image sensor. An output conversion unit is configured to process data obtained from the shift registers and to output processed first data and processed last data. A linearizing unit is configured to perform an operation on both the processed first data and the processed last data to linearize one of the processed first data and the processed last data. A memory is configured to store a correction value between the processed first data and the processed second data. A correcting unit is configured to output corrected data based on the correction value stored in the memory in response to an input of subsequent data scanned by the CCD image sensor.

The present invention further provides an image scanner, including a first memory unit portion configured to store first data corresponding to outputs of a charge-coupled device scanning a first number of positions of a first portion of a correction member having different reflectance values. A second memory unit portion is configured to store second data corresponding to outputs of the charge-coupled device scanning a second number of positions of a second portion of the correction member having different reflectance values. A first transforming unit portion is configured to transform the first data into transformed first data. A second transforming unit portion is configured to transform the second data into transformed second data. A correction unit is configured to generate a table storing relationships between reflectance values and differences of the transformed first data and the transformed second data for a third number of positions greater than each of the first number of positions and the second number of positions.

The present invention further provides an image scanner including a subassembly for storing first data corresponding to outputs of a charge-coupled device scanning a first number of positions of a first portion of a correction member having different reflectance values. A subassembly is used for storing second data corresponding to outputs of the charge-coupled device scanning a second number of positions of a second portion of the correction member having different reflectance values. A subassembly is used for transforming the first data into transformed first data, and a subassembly is used for transforming the second data into transformed second data. A subassembly is used for generating a table storing relationships between reflectance values and differences of the transformed first data and the transformed second data for a third number of positions greater than each of the first number of positions and the second number of positions.

### BRIEF DESCRIPTION OF THE DRAWINGS

A more complete appreciation of the present invention and many of the attendant advantages thereof are readily obtained as the same becomes better understood by reference to the following detailed description when considered in connection with the accompanying drawings, wherein:

FIG. 1 is a cross-sectional view of an image scanner according to the present invention.

FIG. 2 is a schematic view of a CCD including plural shift registers included in the image scanner of FIG. 1.

FIG. 3 is a graph showing differences between a linearity of an output signal and outputs of the CCD.

FIG. 4 is a graph showing a wave pattern output from the CCD.

FIG. 5 is a graph showing differences in output characteristics for reflectances of the document scanned by the CCD.

FIG. 6 is a chart showing examples of average data of a boundary between the first half and the last half from a scanner scanning a 20 tone gray scale chart.

FIG. 7 is a graph illustrating the data of the chart of FIG. 6.

FIG. 8 is a graph showing the last half data as having been linearized, and the first half data being adjusted relative to the linear last half data based on differences between the measures first half data and the measured last half data.

FIG. 9 is a schematic showing an example of an image reading circuit board and an image processing circuit board of the image scanner, in which the γ correction is carried out on the last half data after the first half data has been linearized.

FIG. 10 is a schematic showing an example of the image reading circuit board and the image processing circuit board of the image scanner, in which the γ correction is carried out on the first half data after the last half data has been linearized.

FIG. 11 is a flow chart showing the scanner γ correction based on scanning the gray scale chart placed on the contact glass.

FIG. 12 is a flow chart showing the scanner γ correction based on scanning a gray scale chart as a component of the image scanner.

FIG. 13 is a flow chart showing the scanner γ correction based on user input.

FIG. 14 is a flow chart showing the storing in the memory of detected data for adjustment.

FIG. 15 is a flow chart showing the procedure of making γ correction table operating γ correction characteristics from data stored in the memory when the image scanner is turned on.

FIG. 16 is a flow chart showing the procedure for calculating the γ correction characteristics based on the detected data stored in the memory, when the image scanner is turned on.

FIG. 17 is a flow chart showing the scanner γ correction based on user input.

FIG. 18 is bottom view of the gray scale chart included in the image scanner.

FIG. 19 is a cross-sectional view of the image scanner including the gray scale chart.

FIG. 20 is a graph showing a difference in potential of the φ2B transfer clock based on variations in the CCD.

### DETAILED DESCRIPTION OF THE INVENTION

The invention is now described with reference to the drawings.

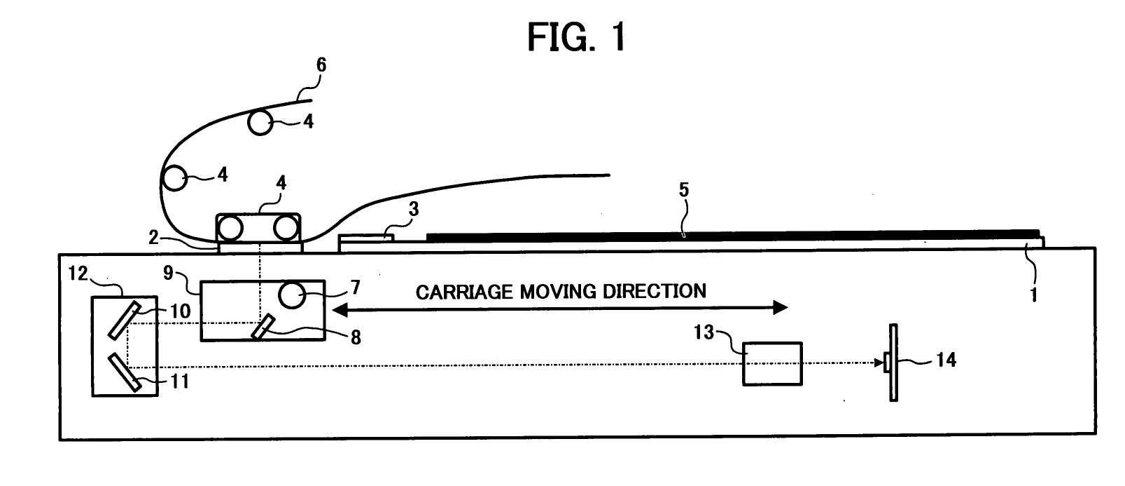

FIG. 1 is a cross-sectional view of an image scanner according to the present invention. The image scanner can includes a contact glass 1 through which a document is scanned, a white board 3 for generating shading data, a first carriage 9 including a lamp 7 for illuminating the document and including a first mirror 8, a second carriage 12 including second and third mirrors 10 and 11, a lens unit 13 for focusing portions of the document reflected by the mirrors 9-11 on a charge-coupled device (CCD), and a signal processing board 14 including the CCD. Although not shown in the drawings, the image scanner can also include drive motors for driving the first and second carriages 9 and 12, a home position sensor, a document detection sensor, and/or other components, including components of known image scanners.

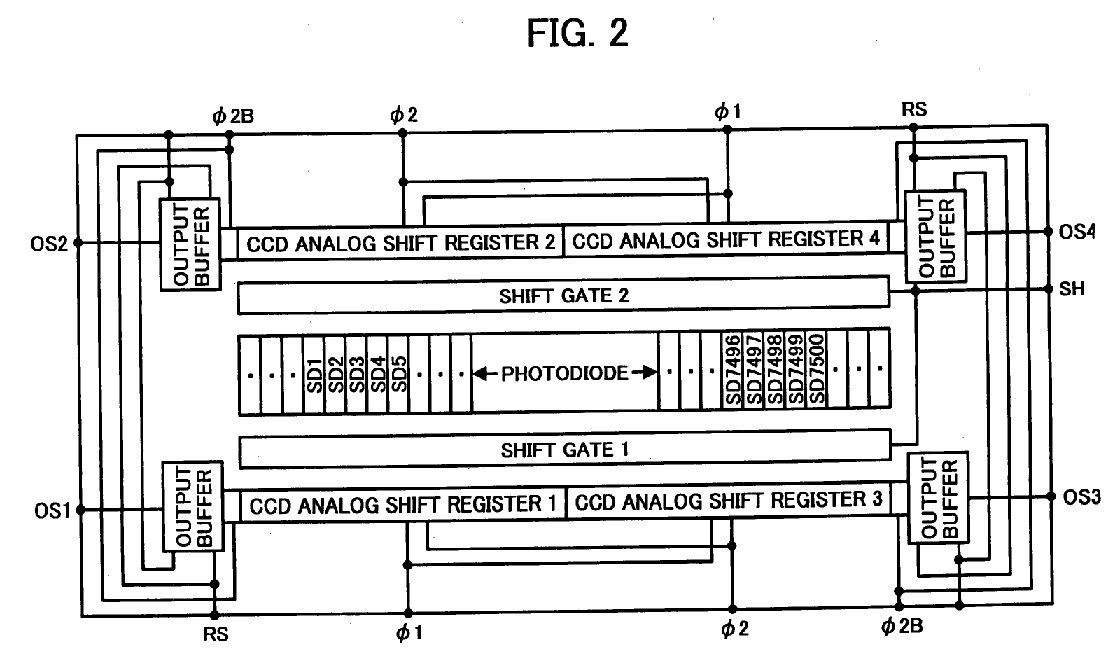

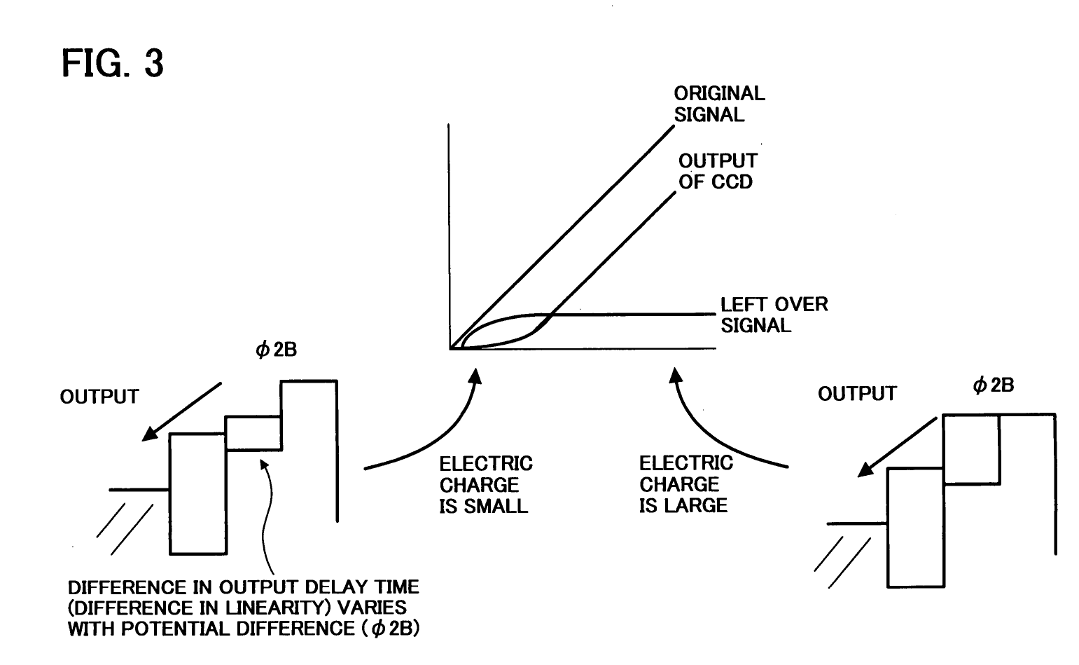

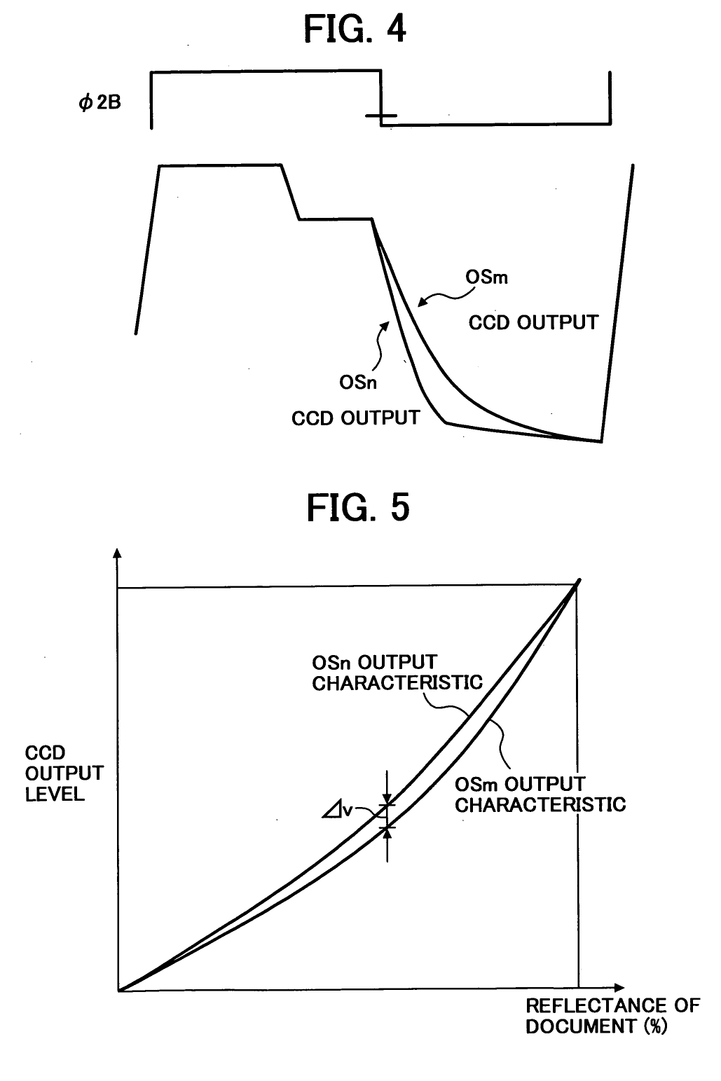

As shown in FIG. 2, the signal processing board 14 can include CCD analog shift registers 1-4 for scanning the document in an expedited manner. Specifically, the CCD analog shift register 1 can output odd number pixel information for a first half of a document, the CCD analog shift register 2 can output even number pixel information for the first half of the document, the CCD analog shift register 3 can output even number pixel information for a last half of the document, and the CCD analog shift register 4 can output odd number pixel information for the last half of the document.

The image scanner can be operated in at least two modes. In a first mode, the document 5 is placed on the contact glass 1, and the lamp 7 is energized. Both the first and second carriages 9 and 12 move along the carriage moving direction of FIG. 1. In this mode, the first and second carriages 9 and 12 scan the whiteboard 3, and generate corresponding shading data, prior to scanning the document 5. Shading compensation processing, based on the shaded data, is performed concurrently with the scanning of the document 5.

In a second mode, a document conveyor 4 conveys the document 6 past the energized lamp 7, while the first and second carriages 9 and 12 remain stationary during scanning of the document 6. In this mode, however, prior to the scanning of the document 6, the first carriage 9 is moved to a position below the whiteboard 3, such that the shaded data is read. The first carriage 9 is moved to a home position prior to the conveyance of the document 6 by the document conveyor 4.

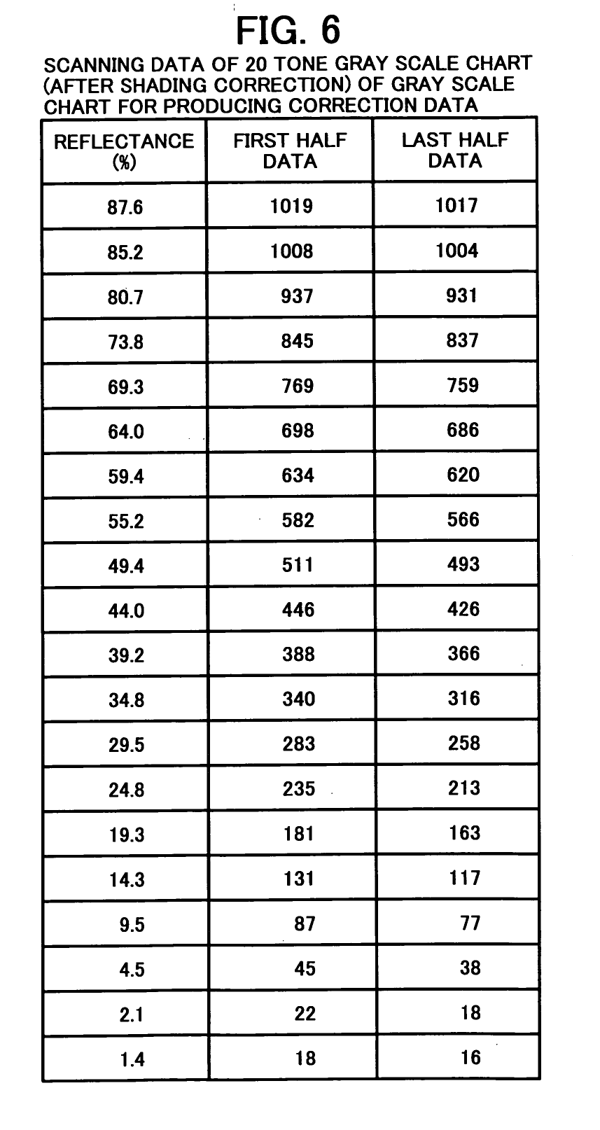

FIG. 6 is a chart showing examples of average data of a boundary between the first half and the last half from a scanner scanning a 20 tone gray scale chart. Reflectance is linearly indicated on the gray scale chart. Specifically, the chart shows scanning data obtained by the CCD shift registers 1 and 2 outputting data from scanning a first half of a gray scale chart, in the column labeled “first half data,” and obtained by CCD analog shift registers 3 and 4 outputting data from scanning the last half of the gray scale chart, in the column labeled “last half data,” at a boundary between the first half and the last half, for detected reflectance values, after shading correction based on the shaded data. The chart shows 20 data points for each of the first and last half data, each of the 20 data points being generated by averaging the values obtained by the CCD analog shift registers outputting information for the even and odd number pixels. It is to be understood that the chart, which includes 40 data points for both the first and last half of the gray scale chart, is an example for one of the four colors (red, green, blue, and black) scanned by the signal processing board 14, and that therefore 160 data points are used to provide a scanner γ correction table for the signal processing board 14 that scans all four colors.

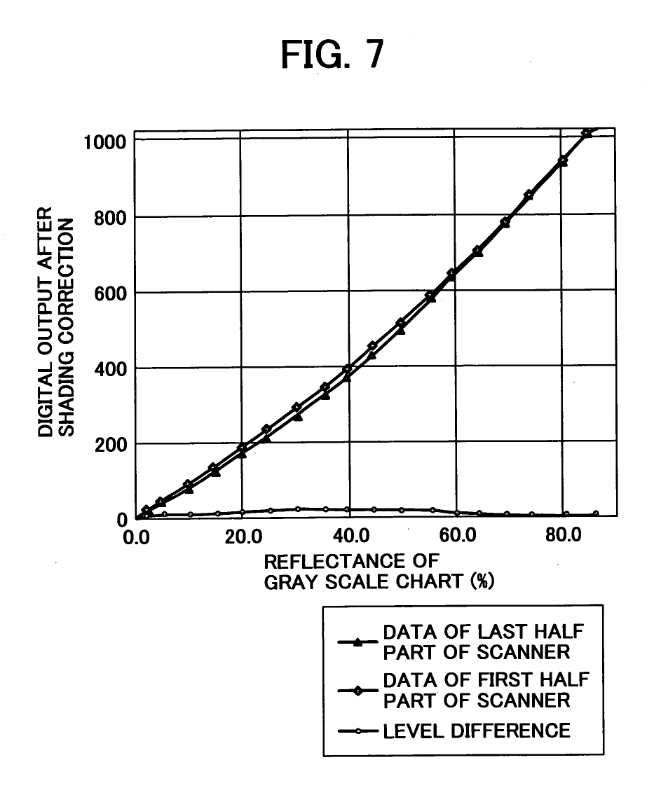

FIG. 7 is a graph illustrating the data of the chart of FIG. 6. In FIG. 7, the Y-axis indicates output data after shading correction, and the X-axis indicates detected reflectance values.

Ideally both of the lines connecting each of the first half data points and the last half data points would be linear, because the gray scale chart is a linear chart. Thus, separate γ correction can be performed on both the first half data and the last half data, to make each of the first half data and the last half data linear.

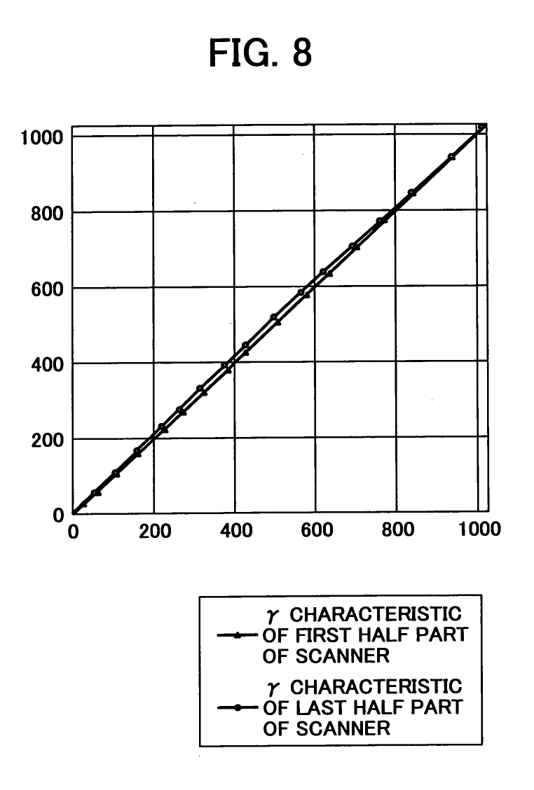

However, it has been determined by the inventor that one of the first half data or the last half data can be corrected to be linear, and the other of the last half data and the first half data can be adjusted based on differences between the measured first half data and the measured last half data, as shown in FIG. 8. Specifically, FIG. 8 shows the last half data as having been linearized, and the first half data being adjusted relative to the linear last half data based on differences between the measures first half data and the measured last half data.

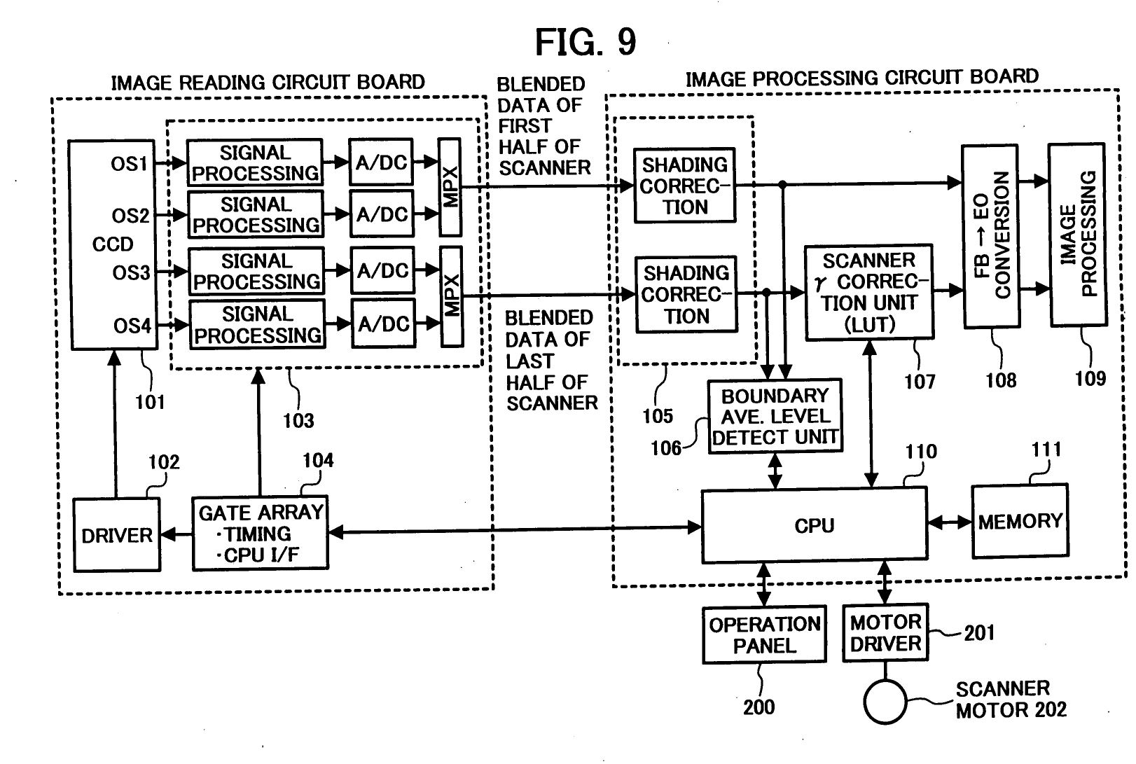

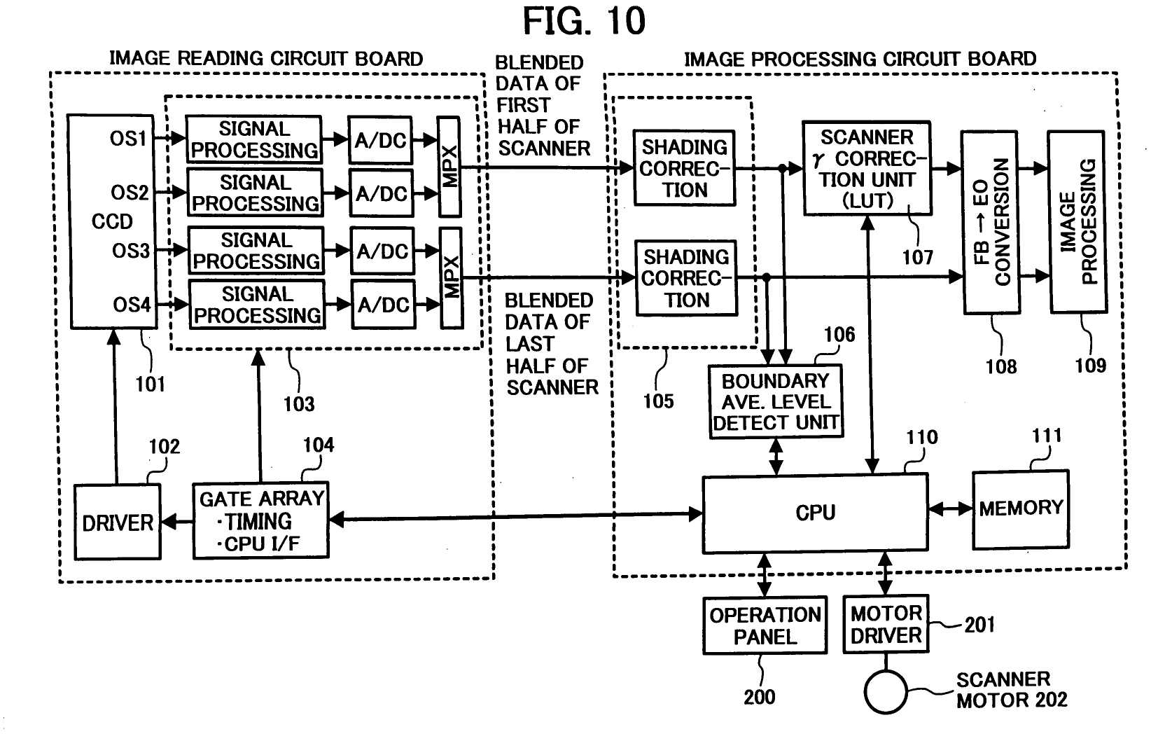

FIG. 9 shows an example of an image reading circuit board and an image processing circuit board of the image scanner, in which the γ correction is carried out on the last half data after the first half data has been linearized. FIG. 10 shows an example of the image reading circuit board and the image processing circuit board of the image scanner, in which the γ correction is carried out on the first half data after the last half data has been linearized. As shown in FIGS. 9 and 10, a scanner γ correction unit 107 can be used on one of the first data half and the second data half, such that two scanner γ corrections unit 107 are not required. By this arrangement, costs of the image scanner are reduced as compared to the image scanner using two such correction units.

The first half data or the last half data can be linearized by any known arithmetic operations. Further, known arithmetic operations can be applied to the other of the last half data or the first half data, which has not been linearized, the adjust the other of the last half data or the first half data based on the linearized one of the first half data and the last half data and the difference between the measured first half data and the measured last half data.

As shown in FIGS. 9 and 10, the image reading circuit board includes a CCD 101 converting light reflected from the document to an analog output, a signal processing unit 103 amplifying and converting the output from the CCD 101 with analog to digital converters (A/DC), a gate array 104 for generating a driving timing of the CCD 101, and a CCD driver 102.

The signal processing unit 103 performs a black offset adjustment as well as a gain adjustment, among other processes. The signal processing unit 103 also blends the data from the even and odd number pixels in the first half data and in the last half data. The data is then output from the image reading circuit board to the image processing circuit board.

The image processing circuit board includes the shading correction unit 105 for performing shading correction on the composed data of the odd number pixels and the even number pixels for each of the first half data and the last half data. A boundary average level detecting unit 106 detects an average level of a boundary of the first half data and the last half data, and sends the information to a CPU (central processing unit) 110.

The image processing circuit board also includes the scanner γ correction unit 107, which as shown in FIG. 9 corrects the composed data of the last half data after shading correction. An FL to EO (first/last to even/odd) converting unit 108 converts the composed data of the first half data after shading correction and the composed data of the last half data after shading correction to the even number pixels and the odd number pixels for each of the first half data and the last half data. An image processing unit 109 performs various image processes in the image processing circuit board. The CPU 110 controls the image processing circuit board and a timing of the image reading circuit board. The operation panel 200 for controlling scanning is connected to the CPU 110, as are a motor driver 201 to control a scanner motor 202 and a memory 111.

As discussed above, as shown in FIG. 9 only the composed data of the last half data is subject to scanner γ correction with the scanner correction γ unit 107 after shading correction, by way of a look-up table (LUT). By this arrangement, it is not necessary to linearize the last half data. Rather, the scanner γ correction is performed on the even and odd number pixels of the last half part, which has not been linearized, and not on the first half part that has been linearized.

After the scanner γ correction, the composed data of the first half data and the composed data of the last half data is separated into even and odd number pixels for the first half data and even and odd number pixels for the last half data. The image is then processed by the image processing unit 109.

The operation unit 200 can be used by an operator to determine conditions under which image scanning is to occur. The operation unit 200 can be used to determine conditions when scanner γ correction occurs, as well as to determine under what conditions the gray scale chart is to be read.

FIG. 10 shows the image reading circuit board and the image processing circuit board, similar to those shown in FIG. 9. FIG. 10 shows, however, the scanner γ correction unit 107 corrects the composed data of the first half data after shading correction, rather than correcting the composed data of the last half data. In this case, the last half data has been linearized. Specifically, the composed data of the first half data undergoes scanner γ correction after shading correction, and the composed data of the last half data does not undergo scanner γ correction. The scanner γ correction occurs on the even number pixels of the first half data and the odd number pixels of the first half data, through the use of the look-up table.

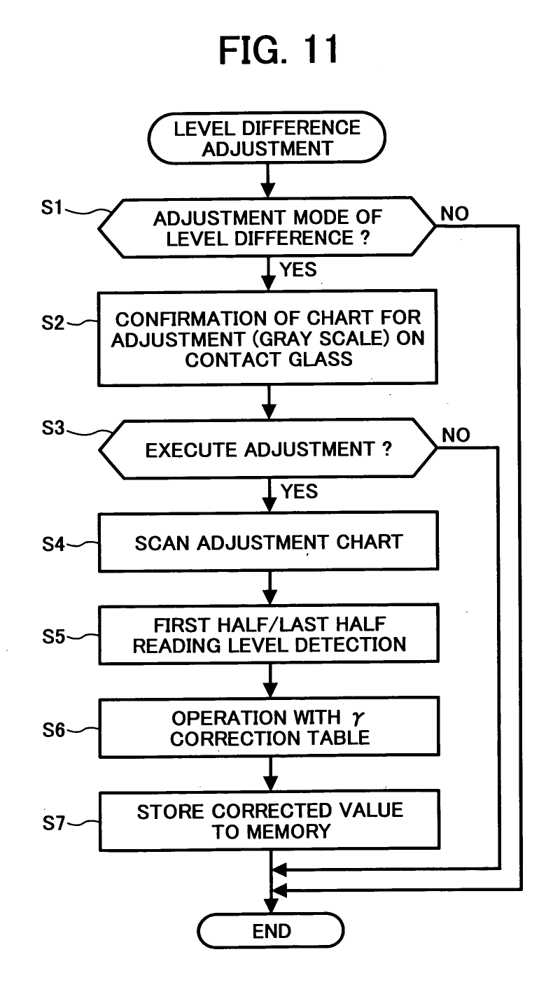

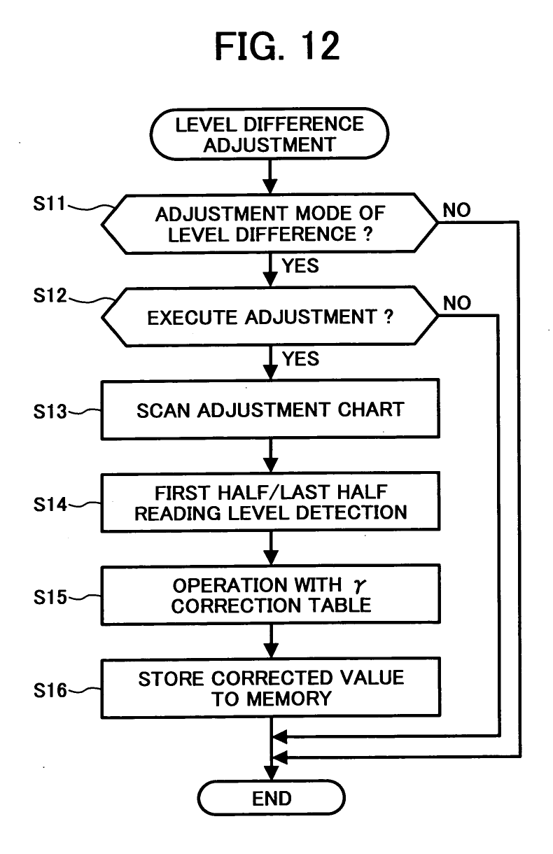

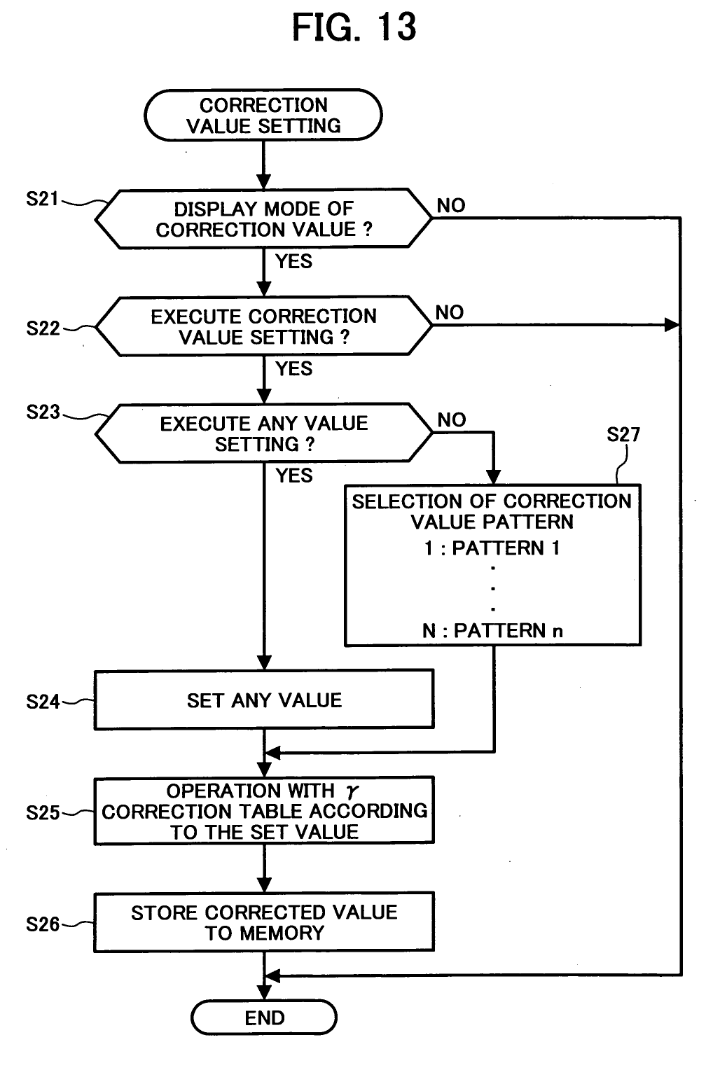

FIGS. 11-13 are flow charts showing methods of adjusting the image scanner. Specifically, FIG. 11 shows the scanner γ correction based on scanning the gray scale chart placed on the contact glass 1. FIG. 12 shows the scanner γ correction based on scanning a gray scale chart as a component of the image scanner. FIG. 13 shows the scanner γ correction based on user input. Because the gray scale chart placed on the contact glass 1 of the image scanner can be larger in size that the gray scale chart disposed in the image scanner, the scanner γ correction based on the separate gray scale chart can provide more precise correction than the scanner γ correction based on the included gray scale chart. For example, as discussed above, the use of the gray scale chart separate from the image scanner can provide 160 data points with which the calibration is conducted. In contrast, because of the smaller size of the gray scale chart included in the image scanner, the use of this smaller gray scale chart generally includes three data points for each of the first half data and the last half data, for each of the four colors, or 24 data points. Because the gray scale chart included in the image scanner provides relatively fewer data points, the image scanner using the separate gray scale chart provides more precise scanner γ correction.

As shown in FIG. 11, when the gray scale chart is placed on the contact glass 1, an operating or adjustment mode of determining the scanner γ correction is determined by input through the operating panel (S1). The operating panel provides confirmation as to whether the gray scale chart for adjustment of the scanner γ correction has been placed on the contact glass 1 (S2).

After placement of the gray scale chart on the contact glass 1 is confirmed, the user confirms that adjustment is to be executed (Yes, at S3), the gray scale chart is scanned by the image scanner (S4). The boundary between the first half portion and last half portion is read, with the image processing circuit board (S5).

A detecting level around the boundary between the first half portion and the last half portion is calculated by an average level, for example of 100×100 pixel data compounded with EO (even/odd) number pixels of the first half and the last half portion in each tone (for example, for 10 to 20 tones) of a gray scale chart. At this time, γ correction is executed as one of the first half data or the last half data is made linear.

When each position of the 20 tones in the gray scale chart is scanned for each of the first half portion and the last half portion, the data for the first half data can be referred to as FD(1), FD(2), FD(3), . . . , FD(18), FD(19) and FD(20), while the data for the last half data can be referred to as LD(1), LD(2), LD(3), . . . , LD(18), LD(19), and LD(20). The first half data can be made linear. The last half data is subject to scanner γ correction. A γ correction table includes a relationship between the first half data and the last half data, such that for a particular last half data LD(n) a corresponding first half data FD(n) is output. By this method, the last half data is subject to scanner γ correction, and the corrected values are applied to the even number pixels and the odd number pixels of the last half data (S6), and the corrected values are stored in the memory (S7).

In a known system, a memory or look-up table stores up to 1024 data points per color, for each of the four colors. However, in the present invention, which uses composed data from odd number pixels and even number pixels, 20 data points are used for each of the first half data and the last half data for each of four colors, or 160 data points for scanner γ correction. Thus, the present invention can use a memory having a relatively smaller storage capacity as compared to the known system.

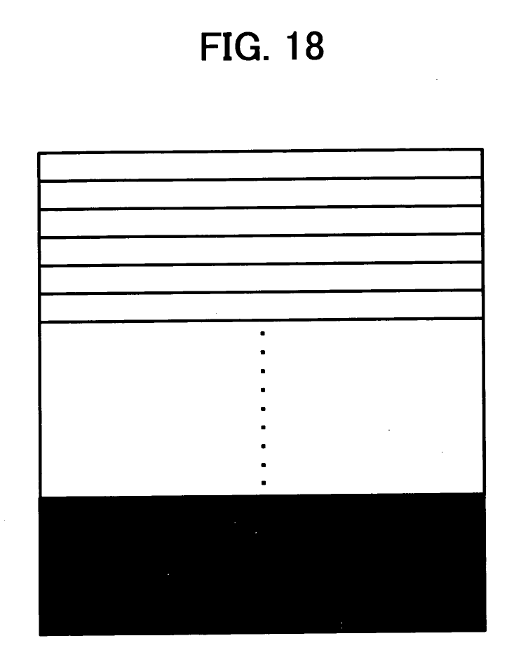

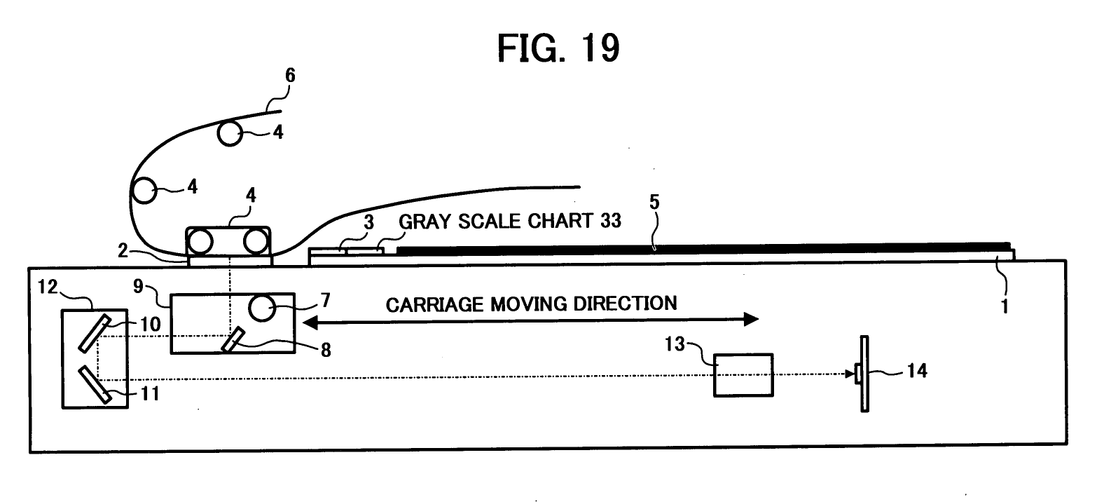

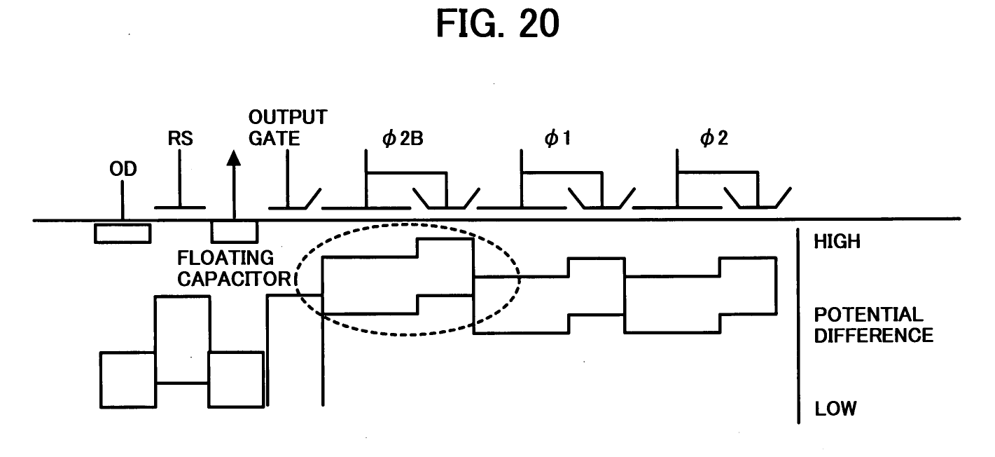

FIG. 18 is bottom view of the gray scale chart included in the image scanner, and FIG. 19 is a cross-sectional view of the image scanner including the gray scale chart. As shown in the figures, the gray scale chart 33 is included as a component of the image scanner. Generally, during manufacture of the image scanner, the image scanner is calibrated by scanning the gray scale chart separate from the image scanner, in accordance with the method shown in FIG. 11. However, in the event that the image scanner loses this initial calibration, for example, the gray scale chart 33 can be used for scanner γ correction, until the image scanner can be recalibrated with the separate, larger gray scale chart permitting more precise calibration. The gray scale chart 33 is linearly shaded, similar to the gray scale chart separate from the image scanner. The gray scale chart 33 can be disposed adjacent the whiteboard 3. Because of the smaller size of the gray scale chart 33 included in the image scanner, the use of this gray scale chart 33 generally includes three data points for each of the first half data and the last half data, for each of the four colors, or 24 data points, as discussed above.

FIG. 12 shows the scanner γ correction based on scanning the gray scale chart 33 as a component of the image scanner. As shown in the figure, an operating or adjustment mode of determining the scanner γ correction is determined by input through the operating panel (S11), and the user confirms that adjustment is to be executed (Yes, at S12). The gray scale chart 33 is scanned by the image scanner (S13). The detected level around the boundary between the first half portion and last half portion is calculated, with the image processing circuit board (S14).

A detecting level around the boundary between the first half portion and the last half portion is calculated by an average level, for example of 100×100 pixel data compounded with EO (even/odd) number pixels of the first half and the last half portion in each tone (for example, for 3 tones) of a gray scale chart. At this time, γ correction is executed as one of the first half data or the last half data is made linear.

When each position of the 3 tones in the gray scale chart is scanned for each of the first half portion and the last half portion, the data for the first half data can be referred to as FD(1), FD(2), FD(3), while the data for the last or back half data can be referred to as LD(1), LD(2), LD(3). The first half data can be made linear. The last half data is subject to scanner γ correction. A γ correction table includes a relationship between the first half data and the last half data, such that for a particular last half data LD(n) a corresponding first half data FD(n) is output. By this method, the last half data is subject to scanner γ correction, and the corrected values are applied to the even number pixels and the odd number pixels of the last half data (S15), and the corrected values are stored in the memory (S16).

An amount of light received by the CCD, or a charging time of the CCD, may be varied, to calibrate the image scanner similar to the calibration with the gray scale chart separate from the image scanner or the gray scale chart 33 as a component of the image scanner.

FIG. 13 shows the scanner γ correction based on user input. As shown in the figure, the operation panel 200 displays a result after setting the scanner γ adjustment mode (S21). The user may select an input mode overwriting previous correction data, including correction data based on a previous image scanner calibration or correction data patterns stored in memory (S22). It is determined (S23) whether a pre-determined correction data pattern like S27 in FIG. 13 (Yes in S23) or whether other data from the user is to be used (No in S23). Plural correction patterns, each subjecting the image to different levels of scanner γ correction, can be stored in the memory. The pattern shown in FIG. 8 is an example of such a pattern.

By this method, the γ correction table is calculated (S25), and the resultant values are stored into a memory as γ correction values (S26) in a manner similar to those discussed above.

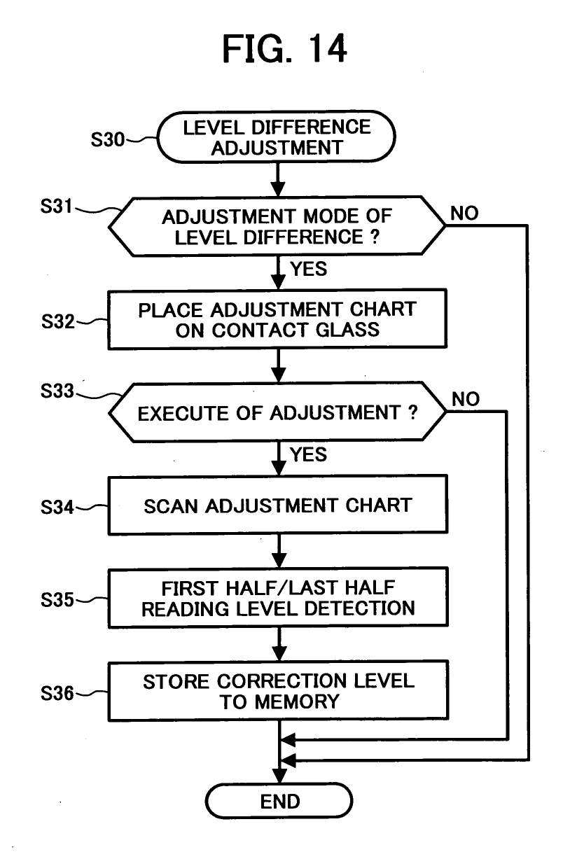

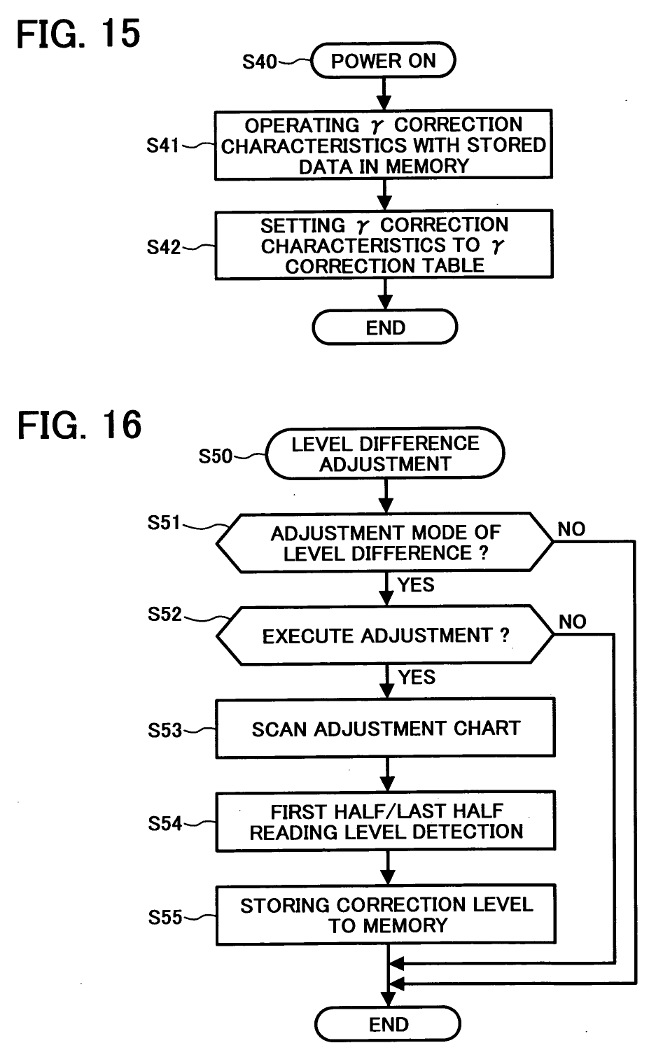

FIGS. 14-16 show variations of the method shown in FIG. 13. FIG. 14 shows a flow chart showing the storing in the memory of detected data for adjustment. FIG. 15 shows the procedure of making γ correction table operating γ correction characteristics from data stored in the memory when the image scanner is turned on. FIG. 16 shows a flow chart for calculating the γ correction characteristics based on the detected data stored in the memory, when the image scanner is turned on.

Specifically, FIG. 14 shows the scanner correction based on scanning the gray scale chart placed on the contact glass 1. FIG. 16 shows the scanner γ correction based on scanning a gray scale chart as a component of the image scanner. Because the gray scale chart placed on the contact glass 1 of the image scanner can be larger in size that the gray scale chart disposed in the image scanner, the scanner γ correction based on the separate gray scale chart can provide more precise correction than the scanner γ correction based on the included gray scale chart. For example, as discussed above, the use of the gray scale chart separate from the image scanner can provide 160 data points with which the calibration is conducted. In contrast, because of the smaller size of the gray scale chart included in the image scanner, the use of this smaller gray scale chart generally includes three data points for each of the first half data and the last half data, for each of the four colors, or 24 data points. Because the gray scale chart included in the image scanner provides relatively fewer data points, the image scanner using the separate gray scale chart provides more precise scanner γ correction.

As shown in FIG. 14, when the gray scale chart is placed on the contact glass 1, an operating or adjustment mode of determining the scanner 7 correction is determined by input through the operating panel (S31). The operating panel provides confirmation as to whether the gray scale chart for adjustment of the scanner γ correction has been placed on the contact glass 1 (S32).

After placement of the gray scale chart on the contact glass 1 is confirmed, the user confirms that adjustment is to be executed (Yes, at S33), the gray scale chart is scanned by the image scanner (S34). The boundary between the first half portion and last half portion is read, with the image processing circuit board (S35).

A detecting level around the boundary between the first half portion and the last half portion is calculated by an average level, for example of 100×100 pixel data compounded with EO (even/odd) number pixels of the first half and the last half portion in each tone (for example, for 3 tones) of a gray scale chart. At this time, γ correction is executed as one of the first half data or the last half data is made linear.

When each position of the 3 tones in the gray scale chart is scanned for each of the first half portion and the last half portion, the data for the first half data can be referred to as FD(1), FD(2), FD(3), . . . , FD(18), FD(19) and FD(20), while the data for the last half data can be referred to as LD(1), LD(2), LD(3), . . . , LD(18), LD(19), and LD(20). These values are stored in the memory (S37).

In this embodiment, as shown in FIG. 15, the γ correction table is created every time the image scanner is energized (the power is turned on). Specifically, the γ correction table is created from previously detected and stored data. In FIG. 15, when the power is turned on (S40), the previously detected and stored data stored in the memory is used to generate the γ correction table, in a manner similar to step S6 in FIG. 11. The γ correction table is applied to the values stored in the memory, such that scanner γ correction is completed.

In the known system, discussed above, a memory or look-up table stores up to 1024 data points per color, for each of the four colors. However, in the present invention, which uses composed data from odd number pixels and even number pixels, 20 data points are used for each of the first half data and the last half data for each of four colors, or 160 data points for scanner γ correction. Thus, the present invention can use a memory having a relatively smaller storage capacity as compared to the known system.

FIG. 16 shows the scanner γ correction based on scanning the gray scale chart as a component of the image scanner. As shown in the figure, an operating or adjustment mode of determining the scanner γ correction is determined by input through the operating panel (S51), and the user confirms that adjustment is to be executed (Yes, at S52). The gray scale chart is scanned by the image scanner (S53). The boundary between the first half portion and last half portion is read, with the image processing circuit board (S54).

A detecting level around the boundary between the first half portion and the last half portion is calculated by an average level, for example of 100×100 pixel data compounded with EO (even/odd) number pixels of the first half and the last half portion in each tone (for example, for 3 tones) of a gray scale chart. At this time, γ correction is executed as one of the first half data or the last half data is made linear.

When each position of the 3 tones in the gray scale chart is scanned for each of the first half portion and the last half portion, the data for the first half data can be referred to as FD(1), FD(2), FD(3), . . . , FD(18), FD(19) and FD(20), while the data for the last half data can be referred to as LD(1), LD(2), LD(3), . . . , LD(18), LD(19), and LD(20). These values are stored in the memory (S55).

In this embodiment, as discussed above and as shown in FIG. 15, the γ correction table is created every time the image scanner is energized (the power is turned on). Specifically, the γ correction table is created from previously detected and stored data. In FIG. 15, when the power is turned on (S40), the previously detected and stored data stored in the memory is used to generate the γ correction table, in a manner similar to step S6 in FIG. 11. The γ correction table is applied to the values stored in the memory, such that scanner γ correction is completed.

In the known system, discussed above, a memory or look-up table stores up to 1024 data points per color, for each of the four colors. However, in the present invention, which uses composed data from odd number pixels and even number pixels, 20 data points are used for each of the first half data and the last half data for each of four colors, or 160 data points for scanner γ correction. Thus, the present invention can use a memory having a relatively smaller storage capacity as compared to the known system.

As discussed above, an amount of light received by the CCD, or a charging time of the CCD, may be varied, to calibrate the image scanner similar to the calibration with the gray scale chart separate from the image scanner or the gray scale chart as a component of the image scanner.

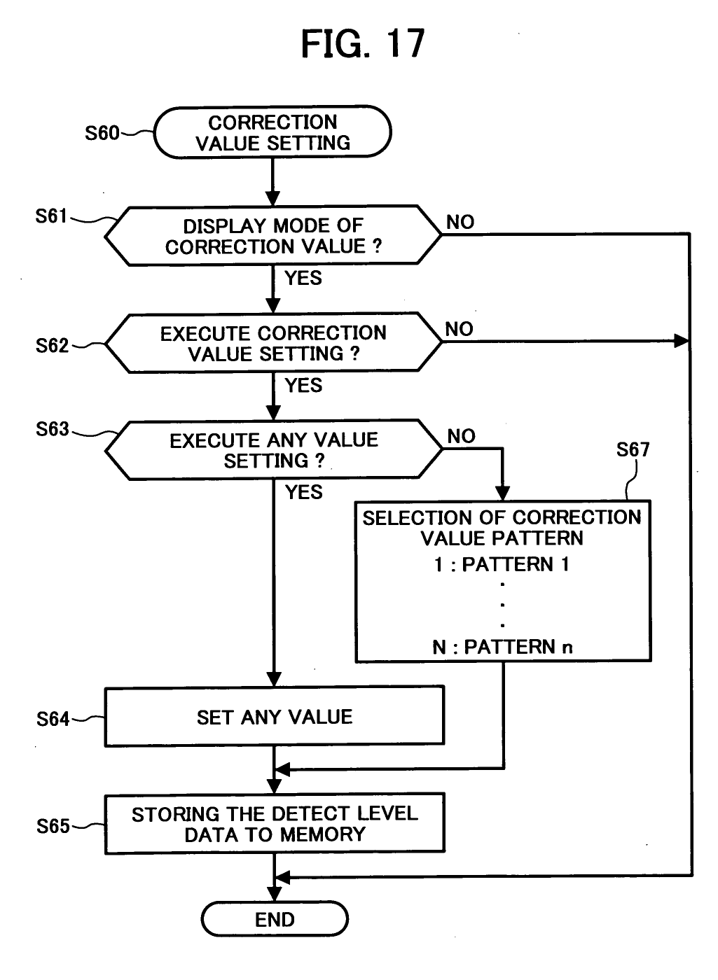

FIG. 17 shows the scanner γ correction based on user input. As shown in the figure, the operation panel 200 displays a result after setting the scanner γ adjustment mode (S61). The user may select an input mode overwriting previous correction data, including correction data based on a previous image scanner calibration or correction data patterns stored in memory (S62). It is determined (S63) whether a pre-determined correction data pattern (S67) or whether other data from the user is to be used. Plural correction patterns, each subjecting the image to different levels of scanner γ correction, can be stored in the memory. The pattern shown in FIG. 8 is an example of such a pattern. By this method, the image is subjected to scanner γ correction (S25 and S26) in a manner similar to those discussed above.

In this embodiment, as discussed above and as shown in FIG. 15, the γ correction table is created every time the image scanner is energized (the power is turned on). Specifically, the γ correction table is created from previously detected and stored data. In FIG. 15, when the power is turned on (S40), the previously detected and stored data stored in the memory is used to generate the γ correction table, in a manner similar to step S6 in FIG. 11. The γ correction table is applied to the values stored in the memory, such that scanner γ correction is completed.

The invention can be applied to a digital copier, a digital multi-function printer, a facsimile machine, and the like.

This patent document is based on and claims priority to Japanese patent application No. 2004-168855 filed on Jun. 7, 2004, the entire contents of which is hereby incorporated by reference.

1. A method of correcting information scanned by an image scanner, comprising:
scanning a first number of positions of a first portion of a correction member having different reflectances to obtain first data;
scanning a second number of positions of a second portion of the correction member having different reflectances to obtain second data;
transforming the first data to obtain transformed first data;
transforming the second data to obtain transformed second data; and
generating a table that includes relationships between reflectances and differences of the transformed first data and the transformed second data for a third number of positions greater than each of the first number of positions and the second number of positions.

2. The method according to claim 1, wherein scanning the first number of positions comprises simultaneously scanning a plurality of locations of the first portion of the correction member having a same reflectance as one another.

3. The method according to claim 1, wherein scanning the second number of positions comprises simultaneously scanning a plurality of locations on the second portion of the correction member having a same reflectance as one another.

4. The method according to claim 3, wherein scanning the first number of positions comprises simultaneously scanning a plurality of locations of the first portion of the correction member having a same reflectance as one another.

5. The method according to claim 1, wherein scanning the first number of positions comprises
simultaneously scanning a plurality of locations of the first portion of the correction member having a same reflectance as one another; and
combining data values from the plurality of locations to obtain a data point of the first data.

6. The method according to claim 1, wherein scanning the second number of positions comprises
simultaneously scanning a plurality of locations of the second portion of the correction member having a same reflectance as one another; and
combining data values from the plurality of locations to obtain a data point of the second data.

7. The method according to claim 6, wherein scanning the first number of positions comprises
simultaneously scanning a plurality of locations of the first portion of the correction member having a same reflectance as one another; and
combining data values from the plurality of locations to obtain a data point of the first data.

8. The method according to claim 1, wherein the first data comprises a plurality of first data points, and the first data points comprise data from a plurality of pixels.

9. The method according to claim 1, wherein the second data comprises a plurality of second data points, and the second data points comprise data from a plurality of pixels.

10. The method according to claim 9, wherein the first data comprises a plurality of first data points, and the first data points comprise data from a plurality of pixels.

11. The method according to claim 1, wherein transforming the first data comprises subjecting the first data to an operation to linearize the first data.

12. The method according to claim 11, wherein transforming the second data comprises subjecting the second data to the operation used to linearize the first data.

13. The method according to claim 12, wherein transforming the second data does not result in the transformed second data being linear.

14. The method according to claim 12, further comprising:
scanning a first half of a document to obtain first document data;
scanning a second half of a document to obtain second document data;
outputting corrected second document data based on the table.

15. The method according to claim 14, further comprising:
transforming the first document data to obtain corrected first document data.

16. The method according to claim 15, further comprising:
transforming the second document data to obtain transformed second; and
inputting into the table the transformed second document data to obtain the corrected second document data.

17. The method according to claim 16, wherein transforming the first document data comprises subjecting the first document data to an operation to linearize the first document data.

18. The method according to claim 17, wherein transforming the second document data comprises subjecting the second document data to the operation to linearize the first document data.

19. The method according to claim 18, wherein transforming the second document data does not result in the transformed second document data being linear.

20. The method according to claim 19, wherein outputting corrected second document data comprises outputting corrected second document data that is linear based on the table.

21. The method according to claim 1, wherein scanning the first number of positions comprises scanning a first half of a gray scale chart, and scanning the second number of positions comprises scanning a second half of a gray scale chart.

22. An image reading apparatus comprising:
a CCD image sensor having plural shift registers configured to output data corresponding to a first portion and a last portion of a correction member scanned by the CCD image sensor;
an output conversion unit configured to process data obtained from the shift registers and to output processed first data and processed last data;
a linearizing unit configured to perform an operation on both the processed first data and the processed last data to linearize one of the processed first data and the processed last data;
a memory configured to store a correction value between the processed first data and the processed second data; and
a correcting unit configured to output corrected data based on the correction value stored in the memory in response to an input of subsequent data scanned by the CCD image sensor.

23. The image reading apparatus as claimed in claim 22, wherein the correction value comprises a predetermined correction value downloaded into the image reading apparatus.

24. The image reading apparatus as claimed in claim 22, further comprising:
a control panel configured to permit modification of the correction value.

25. The image reading apparatus as claimed in claim 22, wherein the correction value is determined by scanning a gray scale chart.

26. The image reading apparatus as claimed in claim 22, further comprising:
a gray scale chart integral with the image reading apparatus, the correction value being determined from the gray scale chart.

27. The image reading apparatus as claimed in claim 23, further comprising:
an interpolation unit configured to provide a greater number of data points in the correction value than a number of the first processed data input to determine the correction value.

28. The image reading apparatus as claimed in claim 22, wherein the memory is configured to store the correction value in a look up table.

29. The image reading apparatus as claimed in claim 22, further comprising:
a control panel configured to convey an instruction, the image reading apparatus being configured to determine the correction value by scanning a gray scale chart in accordance with the instruction.

30. An image scanner, comprising:
a first memory unit portion configured to store first data corresponding to outputs of a charge-coupled device scanning a first number of positions of a first portion of a correction member having different reflectance values;
a second memory unit portion configured to store second data corresponding to outputs of the charge-coupled device scanning a second number of positions of a second portion of the correction member having different reflectance values;
a first transforming unit portion configured to transform the first data into transformed first data;
a second transforming unit portion configured to transform the second data into transformed second data;
a correction unit configured to generate a table storing relationships between reflectance values and differences of the transformed first data and the transformed second data for a third number of positions greater than each of the first number of positions and the second number of positions.

31. The image scanner according to claim 30, wherein the first transforming unit portion is configured to subject the first data to an operation to provide the transformed first data.

32. The image scanner according to claim 31, wherein the second transforming unit portion is configured to subject the second data to the operation to provide the transformed second data.

33. The image scanner according to claim 30, wherein the first transforming portion is configured to subject the first data to an operation to provide linearized transformed first data.

34. The image scanner according to claim 33, wherein the second transforming unit portion is configured to subject the second data to the operation to provide the transformed second data to provide non-linearized transformed second data.

35. The image scanner according to claim 34, further comprising:
a correction chart, integral with the image scanner, configured to provide the first data and the second data.

36. The image scanner according to claim 34, further comprising:
a platen configured to receive a correction chart from which the first data and second data are scanned.

37. An image scanner, comprising:
means for storing first data corresponding to outputs of a charge-coupled device scanning a first number of positions of a first portion of a correction member having different reflectance values;
means for storing second data corresponding to outputs of the charge-coupled device scanning a second number of positions of a second portion of the correction member having different reflectance values;
means for transforming the first data into transformed first data;
means for transforming the second data into transformed second data; and
means for generating a table storing relationships between reflectance values and differences of the transformed first data and the transformed second data for a third number of positions greater than each of the first number of positions and the second number of positions.
